(19) United States
(12) Patent Application Publication
(10) Pub. No.: US 2026/0171936 A1
(43) Pub. Date: Jun. 18, 2026

(54) METHOD FOR OPERATING A BRUSHLESS ELECTRIC MOTOR WITH OPTIMIZED EMERGENCY SHUTDOWN

(71) Applicant: AUMOVIO Germany GmbH, Frankfurt am Main (DE)

(72) Inventors: Peter Stauder, Mainz (DE); Jürgen Böhm, Oberneisen (DE); Achim Netz, Rodgau (DE); Anselm Keil, Amelinghausen (DE)

(73) Assignee: AUMOVIO Germany GmbH, Frankfurt am Main (DE)

(21) Appl. No.: 19/419,176

(22) Filed: Dec. 15, 2025

(30) Foreign Application Priority Data
Dec. 13, 2024 (DE) 10 2024 211 899.

(51) Int. Cl. H02P 6/24; H02P 6/12; H02P 25/03

(52) U.S. Cl. CPC H02P 6/24; H02P 6/12; H02P 25/03; H02P 2207/05

(57) ABSTRACT

A method for operating a brushless electric motor and a correspondingly designed electric motor is disclosed. The electric motor may be a component part of an electromechanical brake device. The method for controlling the electric motor can comprise an actuation circuit and an emergency circuit arrangement, wherein, in a normal operating mode, the electric motor is controlled by the actuation circuit, and wherein in the case of a failure of the actuation circuit, control of the electric motor is taken over by the emergency circuit arrangement based on an emergency stop program.

### TECHNICAL FIELD

The present embodiments generally relate to a method for operating a brushless electric motor and to a correspondingly designed electric motor. The electric motor may be a component part of an electromechanical brake device.

### BACKGROUND

In modern motor vehicles, electromechanically operated wheel brakes (“EMB”) are increasingly used as service brakes. These wheel brakes offer several differences to conventional, hydraulically actuated wheel brakes. They eliminate the need for a complex hydraulic system, and an electromechanical wheel brake is also more space-saving.

Such electromechanical wheel brakes typically have an electronic drive unit, also referred to as a brake actuator, which interacts with a mechanism or a transmission. On the output side, there may then be arranged a brake unit, which may comprise a brake piston and a friction lining which can be pressed against a rotating friction partner, e.g. a brake disk, by means of translational movement. As a result, deceleration can be achieved during operation.

For this purpose, the drive unit typically comprises at least one electric motor which has a correspondingly high power density. Brushless electric motors are now increasingly used for this purpose. The mechanical connection to the friction brake can then be produced by means of at least the transmission, wherein corresponding mechanisms for converting the rotational movement of the electric motor into the required translational or linear movement are known, for example ball screws as rotation/translation converters.

A control unit which can comprise corresponding force controllers is generally provided in order to regulate the electric motor. The force controller can generate a setpoint value for the actuator speed or rotational speed in a known manner based on a predefined setpoint force which can correspond to a driver braking demand, in order to set this setpoint force as quickly as possible. In this way, the wheel brake can be engaged, that is to say, the application force can be applied in the application direction, of the electromechanical motor vehicle brake. In this case, the brake devices of a motor vehicle belong to the safety-relevant systems which are intended to be put into a safe operating state in the event of a dangerous malfunction.

In some applications with electronically controlled brushless electric motors, a safe system state is achieved, for example, by actively moving the electric motor to a predefined operating state, for example a decoupled state in the case of a transmission actuator. However, an electromechanically actuatable brake actuator of said type stores potential energy in the form of a clamping force, for example in the case of a heavily engaged wheel brake. This risk exists for example in disk brakes, in which deformations of the associated caliper housing due to clamping forces can occur, whereby a high clamping force can be built up.

If the control system fails, there is a risk that the electric motor is greatly accelerated backwards on account of the stored energy. If the rotational speed of the motor becomes too high in this case, there is then the risk of damage to the wheel brake, for instance if moving or rotating parts of the electric motor collide with fixed stops. For example, parts of the transmission or of the rotation/translation converter can abut against an end stop and the motor (in which the kinetic energy is located) can generate high forces or torques.

Alternatively, the system can be moved to a safe operating state by mechanical means, for example by decoupling using a spring. However, the use of mechanical means such as a spring can be structurally complex and additionally costly.

Methods for operating a brushless electric motor which do not exhibit, or at least mitigate, the above-mentioned disadvantages are therefore desirable.

### SUMMARY

The method can accordingly be provided for controlling an electric motor having a circuit arrangement correspondingly designed for this purpose. For example, the electric motor can be used as a force actuator for an electromechanical brake device of a motor vehicle.

To this end, the method can comprise an actuation circuit and an emergency circuit arrangement which is separate or largely or completely independent thereof.

The method may comprise the following steps, for example in the order specified: wherein the electric motor is controlled by the actuation circuit in a normal operating mode, wherein operating values of the electric motor are captured by the actuation circuit, wherein an emergency stop program is selected by the actuation circuit based on the operating values, and wherein, in the event of a failure of the actuation circuit, control of the electric motor is performed by the emergency circuit arrangement based on the selected emergency stop program.

The method makes it possible to put an electric motor into a safe operating state if the control by the provided actuation circuit no longer works fully or even fails completely. A safe operating state can be assumed to be a state of the electric motor in which a predetermined rotational speed is no longer exceeded or the electric motor has reached a standstill position.

The protection of the actuator and of the parts of the electric motor can be increased or ensured by means of the method. This is for cases in which another force component acts on the brushless electric motor at the time when the control by the actuation circuit fails, for example as a result of a voltage failure.

The other force component may for example be a clamping force if the electric motor is used as a pressure setting device in an electromechanical brake device of a motor vehicle and the assigned wheel brake is tightly engaged. Thus, in the event of a tight engagement of a disk brake, for example, a deformation of the associated caliper housing can occur, as a result of which this clamping force is stored. When an electromechanical wheel brake engaged in this way is released, damage to components or end stops can occur, because this clamping force can act additively when released. The present embodiments thus allows effective component protection, for instance of the end stops or of the transmission parts, and/or a shortening of the release period.

Accordingly, provision is therefore made for the shortest possible time of self-opening of the electromechanical wheel brake to be achieved as a result of a failure of the associated control by the actuation circuit. Uncontrolled, prolonged unbraked self-opening of the actuator can be avoided in this way.

The electric motor may for example comprise an electronically commutated, permanently excited synchronous machine or a brushless electric motor. Such electric motors can comprise a stator with at least two, or for example three, phase windings and a rotor with at least one pole pair which is arranged perpendicularly to the rotation axis and is formed by one or more permanent magnets which are arranged in or on the rotor. Each phase winding may be assigned a half-bridge to which a supply voltage can be applied. In the case of a three-phase brushless electric motor, three such half-bridges can form what is known as a B6 bridge, which constitutes an inverter. If one or more phase windings are energized, the rotor aligns itself accordingly in the magnetic field that is generated.

The electric motor can be supplied with current in a known manner via the actuation circuit. To this end, the actuation circuit can comprise a microcontroller with suitable processor and storage means. The microcontroller can comprise a pulse width modulation module in order to operate the electric motor by means of pulse width modulation. The actuation circuit can further comprise a driver circuit, for instance in the form of a gate driver unit (GDU). The B6 bridge can be actuated via the driver circuit, as a result of which the electric motor can be operated.

For regular operation of the electric motor, a normal operating mode can be provided in which the electric motor is controlled by the actuation circuit. Regular operation therefore constitutes a non-restricted operating mode in which a correct voltage supply to the actuation circuit is ensured and the actuation circuit functions completely. The actuation circuit can accordingly have a voltage supply, which can be understood to mean a voltage that leads to supplying the electric motor with electric energy. The actuation circuit can accordingly be supplied by a first voltage source. The first voltage source may comprise the on-board power system of a motor vehicle.

Accordingly, an emergency circuit arrangement can further be provided. The emergency circuit arrangement may be configured to control the half-bridges or the inverter. Accordingly, the emergency circuit arrangement can comprise those functions which make it possible to control the inverter.

According to an embodiment, the emergency circuit arrangement is configured to take over the actuation of the electric motor when regular operation of the electric motor by means of the actuation circuit is not possible, for example as a result of a failure of the voltage supply for the actuation circuit. The emergency circuit arrangement can accordingly serve to make emergency operation of the electric motor possible and to ensure said emergency operation for example until a safe operating state of the electric motor is reached. The emergency circuit arrangement can take over the control of the electric motor at least for a predetermined period of time or until a safe operating state is achieved.

The emergency circuit arrangement can be designed independently and/or separately from the actuation circuit in order to be able to continue to operate the inverter in the event of a fault in the regular actuation circuit, for example in the event of a voltage loss. Separate can mean structurally and/or electrically isolated from the actuation circuit. In this way, in the event of a failure of the actuation circuit, the inverter and hence the electric motor can continue to be operated. This makes it possible to bring the electric motor to a safe operating state even in the event of a voltage loss of the on-board electrical system.

To this end, the emergency circuit arrangement can be implemented, for example, as an independent and/or separate processor, microprocessor, or by means of independent and/or separate specific hardware, such as integrated circuits (ASICs) or field-programmable gate arrangements (FPGAs) or a gate driver unit (GDU).

According to an embodiment, the emergency circuit arrangement can have a separate second voltage supply that is independent of the actuation circuit. To this end, according to an embodiment, the emergency circuit arrangement can be supplied by a separate store for electric energy, for example a battery or a capacitor, whereas the actuation circuit can be supplied with power via the onboard power system. The voltage supply by the second voltage source may be maintained until the electric motor has reached the safe operating state. Accordingly, it may suffice to keep available a second voltage source of correspondingly small dimensions.

The emergency circuit arrangement can have a failure detection (“watchdog”) function. In this way, the emergency circuit arrangement can identify when there is a malfunction of the actuation circuit, and control of the electric motor can be transferred to the emergency circuit arrangement.

According to an embodiment, operating values of the electric motor can be captured by the actuation circuit. This can take place at predetermined times or continuously. The operating values of the electric motor can comprise at least one of the following variables: the rotational speed of the electric motor, the absolute value of the current clamping force, the actuating current of the electric motor.

The rotational speed of the electric motor can be determined, for example, by means of a motor position sensor.

The magnitude of the current clamping force can be determined by means of a force sensor, if such a sensor is provided. As an alternative, the requested clamping force may also be taken into account if no sensor is provided or no such signal is available, for example.

The actuating current of the electric motor can be carried out, for example, by measuring the voltage at the driver circuit.

In an embodiment, an emergency stop program can be selected by the actuation circuit based on the operating values. As a result, the emergency stop program which in each case is optimally matched to the current operating state of the electric motor can be selected. In the event of a failure of the actuation circuit, control of the electric motor is performed by the emergency circuit arrangement based on the selected emergency stop program.

This makes it possible that, in the event of a failure of the actuation circuit, emergency operation of the electric motor is promptly initiated in order to achieve a safe operating state, which is determined by the operating state before the failure. This makes it possible to ensure the best possible transfer of the electric motor to the safe operating state, starting from the operating state prevailing at the time of the failure.

According to an embodiment, the actuation circuit can for this purpose have a memory in which a multiplicity of emergency stop programs are stored. Rules or algorithms can be implemented in the actuation circuit which, based on the present operating parameters, select the emergency stop program from the memory which is optimally suited for this purpose in order to put the electric motor into the safe operating state.

According to one embodiment, there can be provision for the actuation circuit to transmit in each case the current emergency stop program to the emergency circuit arrangement, so that, in the event of a switchover, the emergency circuit arrangement then directly executes the last transmitted emergency stop program. Accordingly, provision can be made that, in the event of a failure of the actuation circuit, control of the electric motor is taken over by the emergency circuit arrangement based on the last transmitted emergency stop program.

According to another embodiment, provision can be made for the emergency circuit arrangement to have its own memory and for multiple emergency stop programs to already be stored in this memory of the emergency circuit arrangement. Only very short emergency information about the current emergency stop program to be selected for a failure can then be transmitted to the emergency circuit arrangement by the actuation circuit.

The transmission of the emergency stop program or of the emergency information from the actuation circuit to the emergency circuit arrangement can preferably be effected regularly during operation at short time intervals, for example at least every 100 ms, preferably at least every 50 ms, or every 20 ms or in even quicker succession.

Criteria for selecting the emergency stop program may for example be the current clamping force or the current travel in the case of an electric motor for an electromechanical brake device, wherein the fastest possible achievement of a safe operating state or minimum power consumption may constitute possible selection criteria. Threshold values can also be defined for the operating values, for example, and the corresponding emergency stop program is selected when these values are exceeded or undershot. These threshold values may for example be defined in advance and stored in the microcontroller or another memory component, or else be determined and/or adapted dynamically in the course of the method.

The emergency stop program can include generating a short circuit, at least intermittently, in all engine phases. This time-controlled short circuit allows a rotational movement of the rotor relative to the stator to be slowed down. This may be expedient for example if a force component, for example a clamping force due to a tight engagement of a wheel brake, additionally acts on the rotational movement, such that the rotation can become very fast. In the case of the short circuit, the phase windings can be connected in parallel with one another, causing a short circuit. In this way, the brushless electric motor can, as it were, be set into a generator operation, which results in braking.

Accordingly, the generation of a plurality of short circuits in succession can be provided, for example in the form of pulses. Suitable pulse sequences or the associated duty cycles, but also further parameters for generating short circuits, can be stored in the emergency stop programs and can be selected as a function of the respective operating state. The further parameters may also comprise the time until the first short is generated or the number of repetitions, for example.

In accordance with one further development, the circuit arrangement can comprise a phase separator in each of the motor phases. In the activated state, the emergency circuit arrangement can then actuate these phase separators and in this way put the brushless electric motor into the safe operating state. In this case, the B6 bridge may be in a state of a permanent active short circuit or be actuated accordingly. By means of the phase dividers, a controlled, for example temporally clocked interruption or isolation of the short circuit can then take place in order to actuate the electric motor according to the selected emergency stop program.

Another aspect comprises a circuit arrangement, for example for controlling an electric motor for an electromechanical brake device of a motor vehicle, wherein the circuit arrangement can be designed to carry out a method as described above.

Finally, in yet another aspect, the present embodiment comprises an electromechanical brake device of a motor vehicle, comprising a circuit arrangement as described above.

The electric motor can be used for electromechanically actuatable wheel brakes of the electromechanical brake device, wherein possible uses as a parking brake or else as a service brake are possible.

The electromechanically actuatable wheel brake may be designed either as a disk brake or as a drum brake, for example.

Further details of the embodiments will emerge from the description of the illustrated exemplary embodiments and from the appended claims.

### BRIEF DESCRIPTION OF THE DRAWINGS

In particular:

FIG. 1 shows a simplified illustration of an exemplary embodiment of a circuit arrangement;

FIG. 2 shows a simplified illustration of an exemplary embodiment of a circuit arrangement;

FIG. 3 shows a yet further simplified illustration of an exemplary embodiment of a circuit arrangement having a phase separator in each motor phase, and

FIG. 4 shows an exemplary illustration of parameters of an electric motor, actuated in an operating situation with a failure.

### DETAILED DESCRIPTION

In the following detailed description of the embodiments, identical reference numerals for the sake of clarity denote substantially identical parts in or on these embodiments. The embodiments illustrated in the figures are however not always drawn to scale.

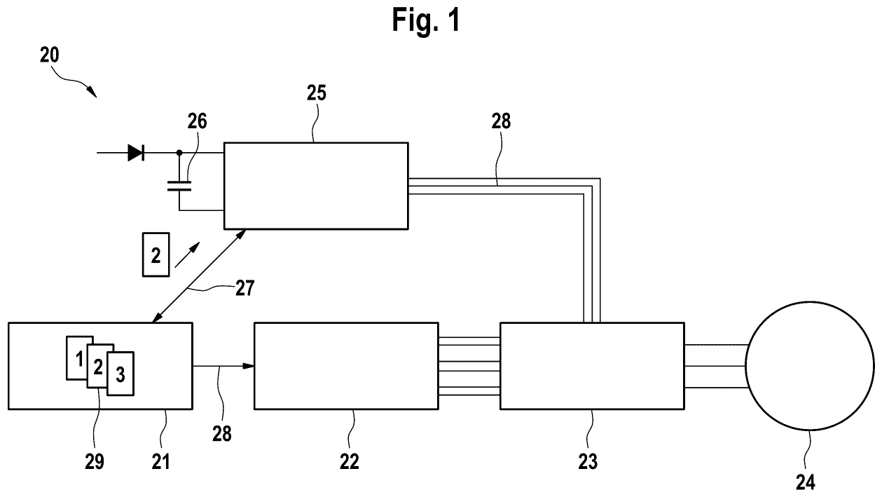

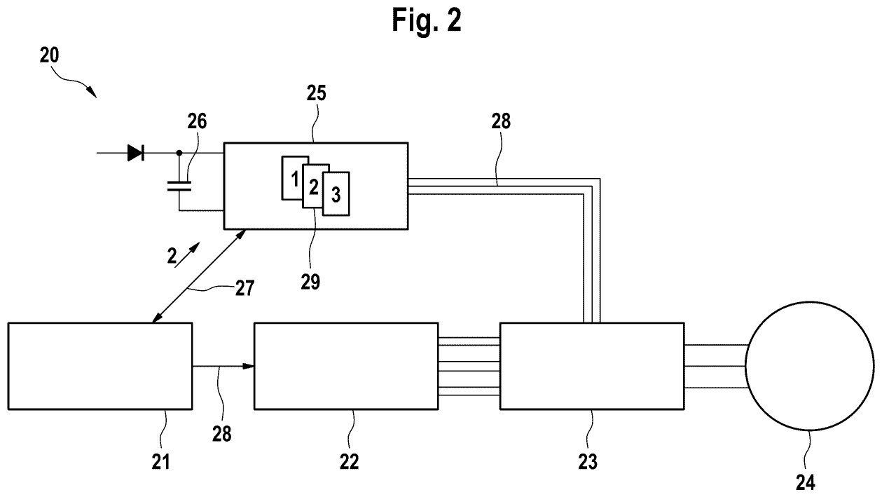

FIG. 1 shows a simplified illustration of an exemplary embodiment of a circuit arrangement 20. For reasons of clarity, only those elements of the circuit arrangement 20 which are relevant to the design of the approach are illustrated here. FIG. 2 shows a simplified illustration of an exemplary embodiment of a circuit arrangement.

The circuit arrangement 20 is provided for controlling an electric motor 24. According to an embodiment, the electric motor 24 is provided as a pressure setting device for an electromechanical brake device of a motor vehicle.

To this end, the method comprises an actuation circuit 21 and an emergency circuit arrangement 25 which is separate or largely or completely independent thereof.

The method provides the following steps in the order illustrated: wherein the electric motor 24 is controlled by the actuation circuit in a normal operating mode, wherein operating values of the electric motor 24 are captured by the actuation circuit, wherein an emergency stop program 29 is selected by the actuation circuit 21 based on the operating values, and wherein, in the event of a failure of the actuation circuit 21, control of the electric motor 24 is performed by the emergency circuit arrangement 25 based on the selected emergency stop program 29.

The method makes it possible to put an electric motor 24 into a safe operating state if the controller or voltage supply of the provided actuation circuit 21 no longer works fully or even fails completely. A safe operating state is assumed to be a state of the electric motor 24 in which a predetermined rotational speed is no longer exceeded or the electric motor has reached a standstill position. Protection of the actuator and of the components of the electric motor 24 can be increased or ensured by means of the method.

In the exemplary embodiment, the electric motor 24 is designed as an electronically commutated, permanently excited synchronous machine with a stator having three phase windings and a rotor. A B6 bridge 23 as an inverter is associated with the phase windings. The electric motor 24 is supplied with power via the actuation circuit 21. To this end, the actuation circuit 21 comprises a microcontroller with suitable processor and storage means. The microcontroller comprises a pulse width modulation module in order to operate the electric motor by means of pulse width modulation. The actuation circuit 21 further comprises a driver circuit 22 or a gate driver unit (GDU), via which the B6 bridge 23 can be actuated. Corresponding electrical connections 28 for transmitting power and signals are provided between the actuation circuit 21 and the driver circuit 22.

For regular operation of the electric motor 24, a normal operating mode is provided in which the electric motor 24 is controlled by the actuation circuit 21. Regular operation therefore constitutes a non-restricted operating mode in which a correct voltage supply to the actuation circuit 21 is ensured and the actuation circuit 21 has its full functionality. The actuation circuit 21 accordingly has a voltage supply (not illustrated in FIG. 1), which is understood to mean a voltage which serves to supply the brushless electric motor 24 with electric energy. The actuation circuit 21 is accordingly supplied by a first voltage source, which in the present case comprises the on-board power supply system of a motor vehicle.

An emergency circuit arrangement 25 may also be provided. This emergency circuit arrangement 25 is configured to control the electric motor 24. To this end, the emergency circuit arrangement 25 comprises those functions that make it possible to actuate the inverter 23. According to an embodiment, the emergency circuit arrangement 25 comprises only those functions which are necessary for controlling the electric motor 24. As a result, costs for configuring the emergency circuit arrangement 25 can be reduced.

The emergency circuit arrangement 25 can thus take over the actuation of the electric motor 24 if regular operation of the electric motor 24 by means of the actuation circuit 21 is not possible, for example as a result of a failure of the voltage supply for the actuation circuit 21. The emergency circuit arrangement 25 accordingly is used to make emergency operation of the electric motor 24 possible and to ensure said emergency operation until the safe operating state is reached. The emergency circuit arrangement 24 can take over the control of the electric motor 24 at least for a predetermined period of time or until a safe operating state is reached.

The emergency circuit arrangement 25 shown in FIGS. 1 and 2 has a separate second voltage supply that is independent of the actuation circuit 21. For this purpose, the emergency circuit arrangement 25 is connected to a second voltage source 26. The exemplary embodiment involves a battery, for example a lithium battery. The second voltage source 26 is configured in this case such that the voltage supply for the emergency circuit arrangement 25 can be maintained until the electric motor 24 has reached the desired safe operating state. The actuation circuit 21 is supplied with power via the onboard electrical system.

In the exemplary embodiments depicted, the emergency circuit arrangement 25 is designed as an independent and/or separate processor or microprocessor. Other embodiments, for instance by means of independent and/or separate specific hardware, integrated circuit (ASIC), or as a field-programmable gate arrangement (FPGAs) or gate driver unit (GDU) are also conceivable and possible.

It is possible to provide the components of the actuation circuit 21 and of the emergency circuit arrangement 25, for example the processors, in a common control unit, wherein care should be taken to ensure appropriate separation with respect to the respective voltage supply, such that in the event of a failure of the actuation circuit 21, the emergency circuit arrangement 25 continues to remain functional independently thereof by means of its own voltage supply 26.

Through the actuation circuit 21, operating values of the electric motor 24 are captured by the actuation circuit 21. This takes place regularly at short time intervals. The captured operating values of the electric motor 24 include: the rotational speed of the electric motor, the absolute value of the current clamping force, the actuating current of the electric motor.

The rotational speed of the electric motor 24 is ascertained by means of a motor position sensor.

The magnitude of the current clamping force is determined by means of a force sensor. As an alternative, the requested clamping force may also be taken into account if no sensor is provided or no such signal is available, for example.

The actuating current of the electric motor 24 is carried out by means of voltage measurement at the driver circuit 22.

Criteria for selecting the emergency stop program may for example be the current clamping force or the current travel in the case of an electric motor 24 for an electromechanical brake device, wherein the fastest possible achievement of a safe operating state or minimum power consumption may constitute possible selection criteria. Threshold values can also be defined for the operating values, for example, and the corresponding emergency stop program is selected when these values are exceeded or undershot. These threshold values may for example be defined in advance and stored in the microcontroller or another memory component, or else be determined and/or adapted dynamically in the course of the method. Therefore, a first emergency stop program 29 may be selected if a particularly high clamping force is applied and there is a high rotational speed of the electric motor 24, and another, second emergency stop program 29 may be selected if the clamping force is lower and/or the rotational speed is lower.

In the event of a failure of the actuation circuit, control of the electric motor 24 can then be taken over by the emergency circuit arrangement based on the selected emergency stop program, wherein emergency operation of the electric motor 24 is promptly initiated in order to reach a safe operating state, which is determined based on the operating state of the electric motor 24 before the failure. This makes it possible to ensure the best possible transfer of the electric motor 24 to the safe operating state, starting from the operating state prevailing at the time of the failure.

For this purpose, according to an embodiment as shown in FIG. 1, the actuation circuit 21 has a memory in which a plurality of emergency stop programs 29 are stored. In the example shown in FIG. 1, three emergency stop programs 29 are shown just for illustrative purposes. Rules or algorithms can be implemented in the actuation circuit 21 which, based on the present operating parameters, select the emergency stop program 29 from the memory which is optimally suited for this purpose in order to put the electric motor 24 into the safe operating state. According to this embodiment, the actuation circuit 21 in each case transmits the currently selected emergency stop program 29 to the emergency circuit arrangement 25 so that the emergency circuit arrangement 25 then directly executes the last transmitted emergency stop program 29 in the event of a switchover. In the exemplary embodiment shown in FIG. 1, the second emergency stop program 29 is currently selected and is transmitted.

According to another embodiment shown in FIG. 2, the emergency circuit arrangement 25 may have its own memory and multiple emergency stop programs 29 are already stored in this memory of the emergency circuit arrangement 25. Only very short emergency information about the current emergency stop program to be selected for a failure can then be transmitted to the emergency circuit arrangement 25 by the actuation circuit 21. In the exemplary embodiment, the second (“2”) emergency stop program 29 is currently selected.

According to a further development, the emergency circuit arrangement 25 has a failure detection (“watchdog”) function. In this way, the emergency circuit arrangement 25 can identify when there is a malfunction of the actuation circuit 21, and control of the electric motor 24 can shift to the emergency circuit arrangement 25. For actuation purposes, the emergency stop program 29 last transmitted or the emergency stop program 29 matching the emergency information can be started.

The transmission of the emergency stop program 29 or of the emergency information from the actuation circuit 21 to the emergency circuit arrangement 25 may be achieved regularly during operation at short time intervals, for example at least every 100 ms, for example at least every 50 ms, or every 20 ms or in even quicker succession.

The emergency stop program 29 comprises a program to generate a short circuit at least intermittently in the motor phases of the electric motor 24, as a result of which a rotational movement of the rotor relative to the stator can be braked. In the case of the short circuit, the phase windings are connected in parallel with one another. In this way, the brushless electric motor 24 can, as it were, be set into a generator operation, which results in braking.

According to one embodiment, generation of at least one or more successive short circuits, for example in the form of pulses, is provided. Various parameters for generating short circuits are stored in the emergency stop program 29. These can include the pulse sequences or the associated duty cycles, the time until the first short is generated, or the number of repetitions. Based on the parameters of the selected emergency stop program 29, the electric motor 24 is actuated by the emergency circuit arrangement 25 in the emergency operating mode until the safe operating state is reached.

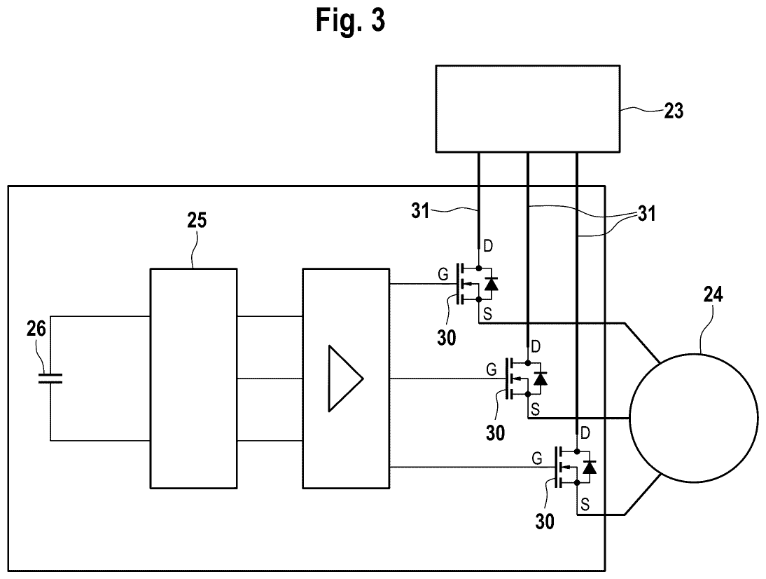

In accordance with a further development, the circuit arrangement 20 comprises a phase separator 30 in each of the motor phases 31. The emergency circuit arrangement 25 actuates the phase dividers 30 in an activated state and in this way puts the electric motor 24 into the safe operating state. In this regard, FIG. 3 shows a further simplified illustration of such a circuit arrangement. The emergency stop program 29 makes it possible here to actuate the phase dividers 30 for controlling the electric motor 24. In this case, the B6 bridge 23 is in a state of a permanent active short circuit or is actuated accordingly. The phase dividers 30 cannot effect a controlled, for example temporally clocked, interruption or elimination of the short circuits in this way. The clock can be set here by means of the emergency stop program 29 and adapted to the current operating situation of the electric motor 24.

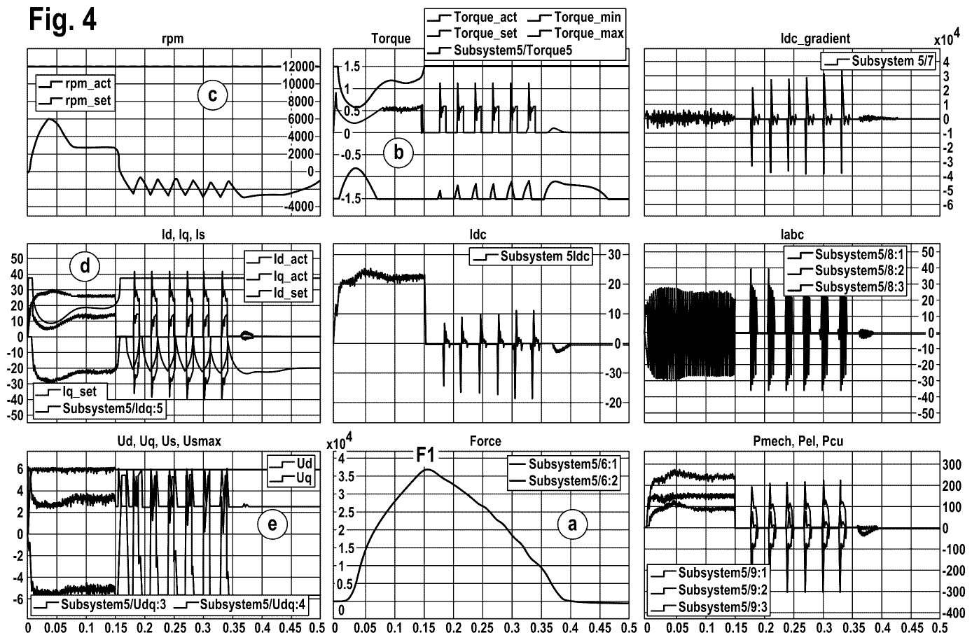

FIG. 4 shows an exemplary illustration of various parameters of a brushless electric motor 24, actuated, during simulated operation over time. In this context, the electric motor 24 is initially actuated such that a predetermined clamping force (“force”) F1 is achieved, as shown in parameter image a. From this moment onward, a failure and actuation by means of the emergency circuit arrangement are simulated in order to put the electric motor 24 into the safe operating state in which the voltage force returns to zero again.

For example, the parameter image c shows here the rotational speed, the parameter image b the torque, the parameter images d and e show the current and voltage profile in the various motor phases.

In another aspect, the embodiment comprises a circuit arrangement 20, in particular for controlling an electric motor 24 for an electromechanical brake device of a motor vehicle, wherein the circuit arrangement 20 is designed for performing a method as described above.

Finally, in yet another aspect, the embodiment comprises an electromechanical brake device of a motor vehicle, comprising a circuit arrangement 20 as described above.

The electric motor 24 can be used for electromechanically actuatable wheel brakes of the electromechanical brake device, wherein uses as a parking brake or else as a service brake are possible.

The electromechanically actuatable wheel brake may be designed either as a disk brake or as a drum brake, for example.

1. A method for controlling an electric motor having a circuit arrangement comprising:
controlling the electric motor in by an actuation circuit in a normal operating mode;
capturing operating values of the electric motor by the actuation circuit;
selecting an emergency stop program by the actuation circuit based on the operating values; and
controlling of the electric motor by an emergency circuit arrangement based on the selected emergency stop program in the event of a failure of the actuation circuit.

2. The method of claim 1, wherein the electric motor comprises an electronically commutated permanently excited synchronous machine.

3. The method of claim 1, wherein the emergency circuit arrangement is designed as a circuit that is at least one of independent and separate from the actuation circuit.

4. The method of claim 1, wherein the emergency circuit arrangement is at least one of; independent and separate processor, in a separate microprocessor, and by at least one of independent and separate specific hardware.

5. The method of claim 4, wherein the emergency circuit arrangement is one of integrated circuits, field-programmable gate arrangements, and a gate-driver unit.

6. The method of claim 1, wherein the actuation circuit is supplied by a first voltage source, wherein the first voltage source is the on-board power supply system of a motor vehicle.

7. The method of claim 1, wherein the emergency circuit arrangement is supplied by a second voltage source which is separate from the first voltage source, wherein the second voltage source comprises a separate store for electrical energy.

8. The method of claim 1, wherein the actuation circuit has a memory with emergency stop programs stored therein, and wherein the currently selected emergency stop program is regularly transmitted to the emergency circuit arrangement.

9. The method of claim 1, wherein the emergency circuit arrangement has a memory with emergency stop programs stored therein, and wherein emergency information relating to the current emergency stop program is transmitted to the emergency circuit arrangement.

10. The method of claim 1, wherein the emergency circuit arrangement has a failure detection function for detecting a failure of the actuation circuit.

11. The method of claim 1, wherein the selection of an emergency stop program and/or the transmission from the actuation circuit to the emergency circuit arrangement takes place continuously.

12. The method of claim 11, wherein at least every 100 ms, at least every 50 ms or every 20 ms.

13. The method of claim 1, wherein the emergency stop program at least temporarily comprises generating a short circuit, wherein the phase windings are connected in parallel with one another, and wherein the emergency stop program specifies pulse sequences provided for generating the short circuits.

14. The method of claim 1, wherein the circuit arrangement comprises a phase separator in each of the motor phases, and wherein the emergency stop program can actuate the phase separators, wherein the B6 bridge of the electric motor is located in an active short circuit.

15. The method of claim 1, wherein the operating values of the electric motor comprise at least one of: the rotational speed of the electric motor, the absolute value of the current clamping force, and the actuating current of the electric motor.

16. A circuit arrangement for controlling an electric motor for an electromechanical brake device of a motor vehicle, comprising:
an actuation circuit, wherein the electric motor is controlled by the actuation circuit in a normal operating mode and wherein operating values of the electric motor are captured by the actuation circuit; and
an emergency circuit arrangement, wherein an emergency stop program is selected by the actuation circuit based on the operating values, and wherein, in the event of a failure of the actuation circuit, control of the electric motor is performed by the emergency circuit arrangement based on the selected emergency stop program.

17. The circuit arrangement of claim 16, wherein the circuit is for an electromechanical brake device of the motor vehicle.
